(19) United States
(12) Patent Application Publication
(10) Pub. No.: US 2026/0070808 A1
(43) Pub. Date: Mar. 12, 2026

(54) Cathode Active Material for Secondary Battery and Secondary Battery Including the Same

(71) Applicant: SK On Co., Ltd., Seoul (KR)

(72) Inventors: Young Hoon DO, Daejeon (KR); Jeong Eun PARK, Daejeon (KR); Hye Jin PARK, Daejeon (KR)

(21) Appl. No.: 19/318,494

(22) Filed: Sep. 4, 2025

(30) Foreign Application Priority Data
Sep. 6, 2024 (KR) 10-2024-0121643

(51) Int. Cl. C01G 53/504; H01M 10/0525

(52) U.S. Cl. CPC C01G 53/504; H01M 10/0525

(57) ABSTRACT

According to embodiments of the present disclosure, a cathode active material for a secondary battery includes first lithium transition metal oxide particles having a single particle form and including cobalt in an amount of 15,000 ppm or less based on their total weight, and second lithium transition metal oxide particles having a secondary particle form and including cobalt in an amount of 15,000 ppm or less based on their total weight. The cobalt content based on the total weight of the first lithium transition metal oxide particles is greater than the cobalt content based on the total weight of the second lithium transition metal oxide particles.

### BACKGROUND

### 1. Field of the Invention

The disclosure of the present application relates to a cathode active material for a secondary battery and a secondary battery including the cathode active material.

### 2. Description of the Related Art

Secondary batteries are batteries that can be repeatedly charged and discharged. With the development of information and communication and display industries, they have been widely applied as power sources for portable electronic communication devices, such as camcorders, mobile phones, and laptop PCs. In addition, battery packs including secondary batteries have recently been developed and applied as power sources for eco-friendly vehicles, such as electric cars.

Examples of the secondary battery include a lithium secondary battery, a nickel-cadmium battery, and a nickel-hydrogen battery. Among these, lithium secondary batteries are actively being researched and developed due to their high operating voltage, high energy density per unit weight, and advantages in charging speed and weight reduction.

A lithium transition metal oxide may be used as a cathode active material for a secondary battery. The manufacturing costs may increase as the cobalt content contained in the lithium transition metal oxide increases. Reducing the cobalt content to decrease costs may degrade the structural stability and output characteristics of the cathode active material.

### SUMMARY

According to an aspect of the present disclosure, a cathode active material for a secondary battery with improved output characteristics and cycle life characteristics may be provided.

According to another aspect of the present disclosure, a secondary battery with improved output characteristics and cycle life characteristics may be provided.

A cathode active material for a secondary battery according to exemplary embodiments of the present disclosure includes: first lithium transition metal oxide particles having a single particle form and including cobalt in an amount of 15,000 ppm or less based on their total weight; and second lithium transition metal oxide particles having a secondary particle form and including cobalt in an amount of 15,000 ppm or less based on their total weight. The cobalt content based on the total weight of the first lithium transition metal oxide particles is greater than the cobalt content based on the total weight of the second lithium transition metal oxide particles.

According to some embodiments, the cobalt content based on the total weight of the first lithium transition metal oxide particles may be 11,000 ppm to 14,000 ppm.

According to some embodiments, the cobalt content based on the total weight of the second lithium transition metal oxide particles may be 5,000 ppm to 9,000 ppm.

According to some embodiments, the first lithium transition metal oxide particles may have a median particle diameter (D50) of 1 μm to 5 μm.

According to some embodiments, the first lithium transition metal oxide particles may have a median particle diameter (D50) of 1.5 μm to 4 μm.

According to some embodiments, the second lithium transition metal oxide particles may have a median particle diameter (D50) of 10 μm to 15 μm.

According to some embodiments, the second lithium transition metal oxide particles may have a median particle diameter (D50) of 11 μm to 13 μm.

According to some embodiments, the cobalt content based on the total weight of the first lithium transition metal oxide particles may be 11,000 ppm to 14,000 ppm, the cobalt content based on the total weight of the second lithium transition metal oxide particles may be 5,000 ppm to 9,000 ppm, the median particle diameter (D50) of the first lithium transition metal oxide particles may be 1 μm to 5 μm, and the median particle diameter (D50) of the second lithium transition metal oxide particles may be 10 μm to 15 μm.

According to some embodiments, the first lithium transition metal oxide particles and the second lithium transition metal oxide particles may each include a layered structure or a crystal structure represented by Formula 1 below:

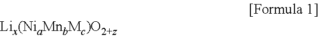

In Formula 1, 0.95≤x≤1.2, 0.5≤a≤0.99, 0.01≤b+c≤0.5, −0.5≤z≤0.1, and M includes Co, and optionally further includes at least one of Al, Na, Mg, Ca, Y, Ti, Hf, V, Nb, Ta, Cr, Mo, W, Fe, Cu, Ag Zn, B, Ga, C, Si, Sn, Sr, Ba, Ra, P and Zr.

According to some embodiments, 0.6≤a<0.8.

According to some embodiments, the content of the first lithium transition metal oxide particles, based on the total weight of the first lithium transition metal oxide particles and the second lithium transition metal oxide particles, may be 10% by weight to 40% by weight.

According to some embodiments, the content of the first lithium transition metal oxide particles, based on the total weight of the first lithium transition metal oxide particles and the second lithium transition metal oxide particles, may be 20% by weight to 40% by weight.

A secondary battery according to exemplary embodiments of the present disclosure includes: a cathode including the cathode active material according to the above-described embodiments; and an anode disposed to face the cathode.

According to some embodiments, the cathode may include a cathode current collector and a cathode active material layer disposed on the cathode current collector, and the cathode active material layer includes the first lithium transition metal oxide particles and the second lithium transition metal oxide particles.

According to some embodiments, the content of the first lithium transition metal oxide particles, based on the total weight of the first lithium transition metal oxide particles and the second lithium transition metal oxide particles, may be 10% by weight to 40% by weight.

According to an embodiment of the present disclosure, a cathode active material for a secondary battery with a relatively reduced cobalt content may be provided.

According to an embodiment of the present disclosure, the cycle life characteristics of the secondary battery may be improved.

According to an embodiment of the present disclosure, the output characteristics of the secondary battery may be improved.

The cathode active material for a secondary battery of the present disclosure and the secondary battery including the same may be widely applied in green technology fields, such as electric vehicles, battery charging stations, as well as solar power generation, wind power generation, and the like, which use the batteries. The cathode active material for a secondary battery of the present disclosure and the secondary battery including the same may be used in eco-friendly electric vehicles, hybrid vehicles, and the like, which are aimed at mitigating climate change by reducing air pollution and greenhouse gas emissions.

### BRIEF DESCRIPTION OF THE DRAWINGS

The above and other objects, features and other advantages of the present disclosure will be more clearly understood from the following detailed description taken in conjunction with the accompanying drawings, in which:

FIGS. 1 and 2 are schematic plan and cross-sectional views illustrating a secondary battery according to some embodiments, respectively.

### DETAILED DESCRIPTION

Embodiments of the present disclosure provide a cathode active material for a secondary battery (hereinafter, also abbreviated as a “cathode active material”). Further, a secondary battery including the cathode active material for a secondary battery is provided.

Hereinafter, embodiments of the present disclosure will be described in detail with reference to the drawings. However, the embodiments are merely illustrative, and the present disclosure is not limited to the specific embodiments described by way of example.

In some embodiments, the cathode active material may include first lithium transition metal oxide particles having a single particle form. Accordingly, the structural stability and high-temperature storage characteristics of the cathode active material may be improved.

The term “single particle,” as used herein, is intended to, for example, exclude secondary particles formed as an integral body by aggregation of a plurality of primary particles. For example, in the first lithium transition metal oxide particles, secondary particle structures formed by aggregation or assembly of primary particles (e.g., greater than 10, 20 or more, 30 or more, 40 or more, or 50 or more) may be excluded.

The term “single particle,” as used herein, does not exclude structures in which 2 to 10 single particles are merely in contact with or adjacent to each other without being integrated into a monolithic structure.

For example, the first lithium transition metal oxide particles may have a granular or spherical form as single particles.

In some embodiments, the cathode active material may include second lithium transition metal oxide particles having a secondary particle form, formed by aggregation of a plurality of primary particles. Accordingly, the cycle life and output characteristics of the secondary battery may be improved.

For example, by using both first lithium transition metal oxide particles having a single particle form and second lithium transition metal oxide particles having a secondary particle form, the interparticle contact area may be increased and changes in lattice volume during repeated charge and discharge cycles may be suppressed. Accordingly, the cycle life characteristics, output characteristics, and high-temperature storage characteristics may be simultaneously improved.

In some embodiments, the cobalt (Co) content based on the total weight of the first lithium transition metal oxide particles may be 15,000 ppm or less, or 1,000 ppm to 15,000 ppm, and the cobalt content based on the total weight of the second lithium transition metal oxide particles may also be 15,000 ppm or less, or 1,000 ppm to 15,000 ppm. In some embodiments, the cobalt (Co) content based on the total weight of the first lithium transition metal oxide particles may be 1,000 ppm or more, 11,000 ppm or more, or 14,000 ppm or less, or 15,000 ppm or less, 14,000 ppm or less, 12,000 ppm or less, or 11,000 ppm or less.

In some embodiments, the cobalt content based on the total weight of the second lithium transition metal oxide particles may be 4,000 ppm to 10,000 ppm. Alternatively, the cobalt content may be 4,000 ppm or more, 5,000 ppm or more, 7,000 ppm or more, or 9,000 ppm or more, or 10,000 ppm or more, 14,000 ppm or less, 12,000 ppm or less, 11,000 ppm or less, or 10,000 ppm or less. Accordingly, the manufacturing costs of the secondary battery may be reduced, while the cycle life characteristics and output characteristics may be improved by using a combination of the above-described first and second lithium transition metal oxide particles.

For example, the first lithium transition metal oxide particles and the second lithium transition metal oxide particles may be provided as cobalt-free or low-cobalt cathode active materials.

In some embodiments, the cobalt content based on the total weight of the first lithium transition metal oxide particles may be greater than the cobalt content based on the total weight of the second lithium transition metal oxide particles. Accordingly, the crystallinity of single particles prepared through relatively high-temperature calcination may be improved, and the output characteristics may be enhanced. Consequently, the cycle life characteristics and output characteristics of the secondary battery may be improved.

In some embodiments, the cobalt content based on the total weight of the first lithium transition metal oxide particles may range from 11,000 ppm to 14,000 ppm. Within the above range, the output characteristics of single particles may be further improved, while manufacturing costs may be reduced.

In some embodiments, the cobalt content based on the total weight of the second lithium transition metal oxide particles may be 5,000 ppm to 9,000 ppm. Within the above range, deterioration in output characteristics may be further prevented, while manufacturing costs may be reduced.

In some embodiments, the first and second lithium transition metal oxide particles may each include a lithium (Li)-nickel (Ni) metal oxide. The lithium-nickel metal oxide may further include at least one of manganese (Mn), aluminum (Al) and cobalt.

In some embodiments, the first lithium transition metal oxide particles and the second lithium transition metal oxide particles may each include a layered structure or a crystal structure represented by Formula 1 below.

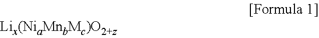

In Formula 1, x, a, b, c and z may satisfy 0.95≤x≤1.2, 0.5≤a≤0.99, 0.01≤b+c≤0.5, and −0.5≤z≤0.1. M includes Co, and optionally may further include at least one of Al, Na, Mg, Ca, Y, Ti, Hf, V, Nb, Ta, Cr, Mo, W, Fe, Cu, Ag, Zn, B, Ga, C, Si, Sn, Sr, Ba, Ra, P and Zr.

In some embodiments, in Formula 1, a may be in the range of 0.6≤a<0.8. Accordingly, the first and second lithium transition metal oxide particles may be provided as mid-nickel (Mid-Ni) cathode active materials, thereby further improving the cycle life characteristics and high-temperature storage characteristics of the secondary battery.

For example, the lithium-nickel metal oxide particles may include a nickel-manganese-based lithium oxide. The nickel-manganese lithium oxide may be doped with a small amount of cobalt (e.g., 15,000 ppm or less based on the total weight) as a doping element.

Ni may be provided as a transition metal associated with the output and capacity of the lithium secondary battery. Therefore, as described above, by employing a high-content (high-Ni) composition in the cathode active material, a high-capacity cathode and a high-capacity lithium secondary battery may be provided.

However, as the Ni content increases, the long-term storage stability and cycle life stability of the cathode or the secondary battery may relatively decrease, and side reactions with the electrolyte may also increase. However, according to exemplary embodiments, the cycle life stability and capacity retention characteristics may be improved through Mn while maintaining electrical conductivity by including a small amount of Co.

The content of Ni in the first lithium transition metal oxide particles (e.g., the molar ratio of nickel included in the first lithium transition metal oxide particles to the total molar amount of metals excluding lithium in the first lithium transition metal oxide particles) may be 0.5 or more, 0.6 or more, 0.7 or more, 0.8 or more, 0.9 or more, or 0.95 or more. In some embodiments, the content of Ni may be 0.8 to 0.98, 0.82 to 0.98, 0.83 to 0.98, 0.84 to 0.98, 0.85 to 0.98, 0.88 to 0.98, or 0.9 to 0.98.

The content of Ni in the second lithium transition metal oxide particles (e.g., the molar ratio of nickel included in the second lithium transition metal oxide particles to the total molar amount of metals excluding lithium in the second lithium transition metal oxide particles) may be 0.5 or more, 0.6 or more, 0.7 or more, 0.8 or more, 0.9 or more, or 0.95 or more. In some embodiments, the content of Ni may be 0.8 to 0.98, 0.82 to 0.98, 0.83 to 0.98, 0.84 to 0.98, 0.85 to 0.98, 0.88 to 0.98, or 0.9 to 0.98.

In some embodiments, the first and second lithium transition metal oxide particles may each further include a coating element or a doping element. For example, elements substantially identical or similar to M in Formula 1 described above may be used as the coating element or the doping element. For example, the above-described elements may be used as the coating element or the doping element alone or in combination with two or more elements.

The coating element or the doping element may be present on the surfaces of the first and second lithium transition metal oxide particles, or may penetrate through the surfaces of the first and second lithium transition metal oxide particles to be incorporated into the layered structure or the crystal structure represented by Formula 1.

For example, the cathode active material may include a plurality of first lithium transition metal oxide particles and a plurality of second lithium transition metal oxide particles.

In some embodiments, the first lithium transition metal oxide particles may have a median particle diameter (D50) of 1 μm to 5 μm, and in one embodiment, 1.5 μm to 4 μm. In some embodiments, the first lithium transition metal oxide particles may have a median particle diameter (D50) of 0.5 μm or more, 1 μm or more, or 3.5 μm or more. Alternatively, D50 may be 5 μm or less, 3.5 μm or less, 1 μm or less, or 0.5 μm or less.

Within the above range, the cycle life characteristics, output characteristics, and storage characteristics of the secondary battery may be further improved.

In some embodiments, the second lithium transition metal oxide particles may have a median particle diameter (D50) of 10 μm to 15 μm, and in one embodiment, 11 μm to 13 μm. In some embodiments, the second lithium transition metal oxide particles may have a median particle diameter (D50) of 9 μm or more, 10 μm or more, 12 μm or more, or 15 μm or more. Alternatively, D50 may be 16 μm or less, 15 μm or less, 12 μm or less, 10 μm or less, or 9 μm or less. Within the above ranges, the cycle life characteristics, output characteristics, and storage characteristics of the secondary battery may be further improved.

As used herein, the term “median particle diameter” or “D50” may refer to the particle diameter at which the cumulative volume percentage in the particle size distribution, obtained based on particle volume, reaches 50%.

In some embodiments, the content of the first lithium transition metal oxide particles, based on the total weight of the first lithium transition metal oxide particles and the second lithium transition metal oxide particles, may be 10 wt % to 40 wt %, and in one embodiment, 20 wt % to 40 wt %. Alternatively, in some embodiments, the content of the first lithium transition metal oxide particles may be 10 wt % to 90 wt %. Alternatively, in some embodiments, the content of the first lithium transition metal oxide particles may be 10 wt % or more, 20 wt % or more, 30 wt % or more, 40 wt % or more, 50 wt % or more, 60 wt % or more, 70 wt % or more, or 80 wt % or more, or 90 wt % or less, 80 wt % or less, 70 wt % or less, 60 wt % or less, 50 wt % or less, 40 wt % or less, 30 wt % or less, or 20 wt % or less. Within the above range, the capacity characteristics and output characteristics of the secondary battery may be sufficiently improved, while the cycle life characteristics and high-temperature storage characteristics may also be enhanced. For example, the weight ratio of the first lithium transition metal oxide particles to the second lithium transition metal oxide particles may be 1:9 to 4:6 or 2:8

In some embodiments, the content of the second lithium transition metal oxide particles, based on the total weight of the first lithium transition metal oxide particles and the second lithium transition metal oxide particles, may be 10 wt % to 90 wt %. The content of the second lithium transition metal oxide particles may be 10 wt % or more, 20 wt % or more, 30 wt % or more, 40 wt % or more, 50 wt % or more, 60 wt % or more, 70 wt % or more, or 80 wt % or more, or 90 wt % or less, 80 wt % or less, 70 wt % or less, 60 wt % or less, 50 wt % or less, 40 wt % or less, 30 wt % or less, or 20 wt % or less.

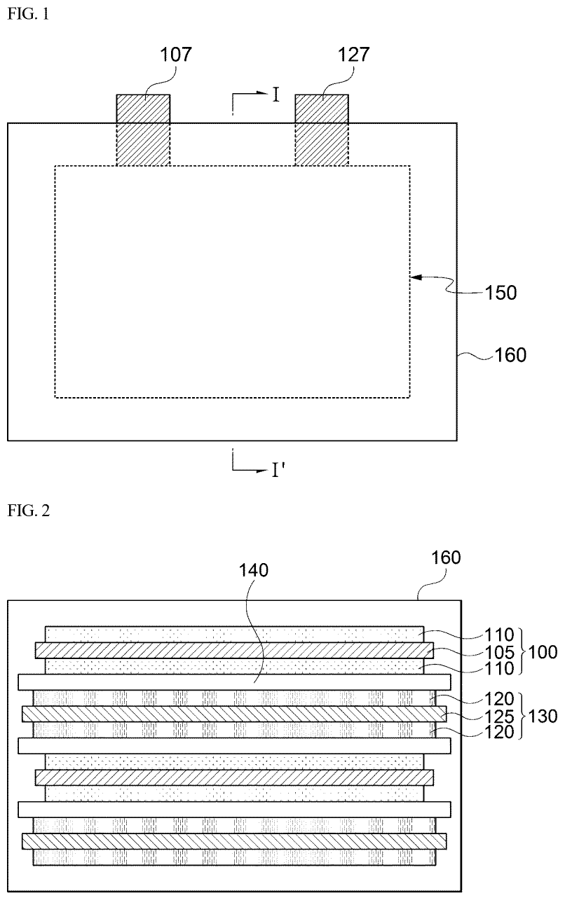

FIGS. 1 and 2 are schematic plan and cross-sectional views illustrating a lithium secondary battery according to exemplary embodiments, respectively. For example, FIG. 2 is a cross-sectional view taken along line I-I′ of FIG. 1 in the thickness direction.

The structures illustrated in FIGS. 1 and 2 are examples for the convenience of description, and the structure of the lithium secondary battery according to the embodiments of the present disclosure is not limited thereto.

Referring to FIGS. 1 and 2, the secondary battery may include a cathode 100 including the above-described cathode active material and an anode 130 disposed to face the cathode 100.

The cathode 100 may include a cathode current collector 105 and a cathode active material layer 110 formed on at least one surface of the cathode current collector 105. The cathode active material layer 110 may include the above-described first lithium transition metal oxide particles and the second lithium transition metal oxide particles.

The cathode current collector 105 may include stainless steel, nickel, aluminum, titanium, copper, or an alloy thereof. The cathode current collector 105 may also include aluminum or stainless steel having a surface treated with carbon, nickel, titanium, copper or silver. For example, the cathode current collector 105 may have a thickness of 10 μm to 50 μm.

The cathode active material layer 110 may include the above-described cathode active material.

The cathode active material may be mixed in a solvent to prepare a cathode slurry. The cathode slurry may be coated on at least one surface of the cathode current collector 105, then dried and roll-pressed to prepare the cathode active material layer 110. The coating may include a method such as gravure coating, slot die coating, simultaneous multilayer die coating, imprinting, doctor blade coating, dip coating, bar coating or casting. The cathode active material layer 110 may further include a binder, and optionally further include a conductive material, a thickener or the like.

As the solvent, N-methyl-2-pyrrolidone (NMP), dimethylformamide, dimethylacetamide, N,N-dimethylaminopropylamine, ethylene oxide, tetrahydrofuran, and the like may be used.

The binder may include polyvinylidene fluoride (PVDF), poly(vinylidene fluoride-co-hexafluoropropylene), polyacrylonitrile, polymethylmethacrylate, acrylonitrile butadiene rubber (NBR), polybutadiene rubber (BR), styrene-butadiene rubber (SBR) and the like. These may be used alone or in combination of two or more thereof.

In one embodiment, a PVDF-based binder may be used as the cathode binder. In this case, the amount of binder for forming the cathode active material layer 110 may be decreased and the amount of the cathode active material may be relatively increased. Accordingly, the output characteristics and capacity characteristics of the secondary battery may be improved.

The conductive material may be added to the cathode active material layer 110 in order to enhance the conductivity thereof and/or the mobility of lithium ions or electrons. For example, the conductive material may include carbon-based conductive materials such as graphite, carbon black, acetylene black, Ketjen black, graphene, vapor-grown carbon fibers (VGCFs), carbon nanotubes (CNTs) carbon fibers, and/or metal-based conductive materials, including perovskite materials, such as tin, tin oxide, titanium oxide, LaSrCoO₃, and LaSrMnO₃. These may be used alone or in combination of two or more thereof.

The cathode slurry may further include a thickener and/or dispersant. In one embodiment, the cathode slurry may include a thickener such as carboxymethyl cellulose (CMC).

The anode 130 may include an anode current collector 125, and an anode active material layer 120 formed on at least one surface of the anode current collector 125.

For example, the anode current collector 125 may include a copper foil, a nickel foil, a stainless steel foil, a titanium foil, a nickel foam, a copper foam, a polymer substrate coated with conductive metal and the like. These may be used alone or in combination of two or more thereof. For example, the anode current collector 125 may have a thickness of 10 μm to 50 μm.

The anode active material layer 120 may include an anode active material. As the anode active material, a material capable of intercalating and deintercalating lithium ions may be used. For example, as the anode active material, carbon-based materials such as crystalline carbon, amorphous carbon, carbon composite, or carbon fibers, etc.; lithium metal; a lithium alloy; a silicon (Si)-containing material or a tin (Sn)-containing material, etc. may be used. These may be used alone or in combination of two or more thereof.

The amorphous carbon may include hard carbon, soft carbon, coke, mesocarbon microbead (MCMB), mesophase pitch-based carbon fiber (MPCF) or the like.

The crystalline carbon may include graphite-based carbon such as natural graphite, artificial graphite, graphitized coke, graphitized MCMB, graphitized MPCF or the like.

The lithium metal may include pure lithium metal and/or lithium metal having a protective layer formed thereon for suppressing dendrite growth and the like. In one embodiment, a lithium metal-containing layer deposited or coated on the anode current collector 125 may also be used as the anode active material layer 120. In one embodiment, a lithium thin film layer may also be used as the anode active material layer 120.

Elements contained in the lithium alloy may include aluminum, zinc, bismuth, cadmium, antimony, silicon, lead, tin, gallium, indium, etc. These may be used alone or in combination of two or more thereof.

The silicon-containing material may provide further increased capacity characteristics. The silicon-containing material may include Si, SiOₓ (0<x<2), metal-doped SiOₓ (0<x<2), a silicon-carbon composite, etc.

The metal may include lithium and/or magnesium, and the metal-doped SiOₓ (0<x<2) may include a metal silicate.

The anode active material may be mixed in a solvent to prepare an anode slurry. The anode slurry may be coated or deposited on the anode current collector 125, and then dried and roll-pressed to prepare the anode active material layer 120. The coating may include processes such as gravure coating, slot die coating, simultaneous multilayer die coating, imprinting, doctor blade coating, dip coating, bar coating or casting, etc. The anode active material layer 120 may further include a binder, and optionally may further include a conductive material, a thickener or the like.

The sol vent included in the anode slurry may include water, pure water, deionized water, distilled water, ethanol, isopropanol, methanol, acetone, n-propanol, t-butanol and the like. These may be used alone or in combination of two or more thereof.

The above-described materials that can be used when preparing the cathode 100 as the binder, conductive material and thickener may also be used for the anode.

In some embodiments, a styrene-butadiene rubber (SBR)-based binder, carboxymethyl cellulose (CMC), polyacrylic acid-based binder, poly(3,4-ethylenedioxythiophene) (PEDOT)-based binder, and the like may be used as an anode binder. These may be used alone or in combination of two or more thereof.

In exemplary embodiments, a separation membrane 140 may be interposed between the cathode 100 and the anode 130. The separation membrane 140 may be configured to prevent an electrical short-circuit between the cathode 100 and the anode 130, and to allow the flow of ions. For example, the separation membrane may have a thickness of 10 μm to 20 μm.

For example, the separation membrane 140 may include a porous polymer film or a porous nonwoven fabric.

The porous polymer film may include a polyolefin-based polymer such as an ethylene polymer, a propylene polymer, an ethylene/butene copolymer, an ethylene/hexene copolymer, and an ethylene/methacrylate copolymer, etc. These may be used alone or in combination of two or more thereof.

The porous nonwoven fabric may include glass fibers having a high melting point, polyethylene terephthalate fibers, etc.

The separation membrane 140 may also include a ceramic-based material. For example, inorganic particles may be coated on the polymer film or dispersed within the polymer film to improve heat resistance.

The separation membrane 140 may have a single-layer or multi-layer structure including the above-described polymer film and/or non-woven fabric.

According to exemplary embodiments, an electrode cell may be defined by the cathode 100, the anode 130 and the separation membrane 140, and a plurality of electrode cells may be stacked to form, for example, a jelly roll type electrode assembly 150. For example, the electrode assembly 150 may be formed by winding, stacking, z-folding, or stack-folding the separation membrane 140.

The electrode assembly 150 may be accommodated in a case 160 together with the electrolyte to define a lithium secondary battery. According to exemplary embodiments, a non-aqueous electrolyte may be used as the electrolyte.

The non-aqueous electrolyte may include a lithium salt of an electrolyte and an organic solvent, the lithium salt is represented by, for example, Li⁺X; and as an anion (X⁻) of the lithium salt, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)PF₂⁻, (CF₃)PF⁻, (CF₃)P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻, etc. may be exemplified.

As the organic solvent, for example, propylene carbonate (PC), ethylene carbonate (EC), butylene carbonate, diethyl carbonate (DEC), dimethyl carbonate (DMC), ethyl methyl carbonate (EMC), methyl propyl carbonate, ethylpropyl carbonate, dipropyl carbonate, vinylene carbonate, methyl acetate (MA), ethyl acetate (EA), n-propylacetate (n-PA), 1,1-dimethylethyl acetate (DMEA), methyl propionate (MP), ethyl propionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ether (DEGDME), dimethoxyethane, tetrahydrofuran (THF), 2-methyltetrahydrofuran, ethyl alcohol, isopropyl alcohol, dimethyl sulfoxide, acetonitrile, diethoxyethane, sulfolane, gamma-butyrolactone, propylene sulfite, and the like may be used. These may be used alone or in combination of two or more thereof.

The non-aqueous electrolyte may further include an additive. The additive may include, for example, a cyclic carbonate compound, a fluorine-substituted carbonate compound, a sultone compound, a cyclic sulfate compound, a cyclic sulfite compound, a phosphate compound, a borate compound and the like. These may be used alone or in combination of two or more thereof.

The cyclic carbonate compound may include vinylene carbonate (VC), vinyl ethylene carbonate (VEC), etc.

The fluorine-substituted carbonate compound may include fluoroethylene carbonate (FEC), etc.

The sultone compound may include 1,3-propane sultone, 1,3-propene sultone, 1,4-butane sultone, etc.

The cyclic sulfate compound may include 1,2-ethylene sulfate, 1,2-propylene sulfate, etc.

The cyclic sulfite compound may include ethylene sulfite, butylene sulfite, etc.

The phosphate compound may include lithium difluoro bis(oxalato)phosphate, lithium difluoro phosphate, etc.

The borate compound may include lithium bis(oxalate) borate, etc.

In some embodiments, a solid electrolyte may be used in place of the above-described non-aqueous electrolyte. In this case, the lithium secondary battery may be manufactured in the form of an all-solid-state battery. In addition, a solid electrolyte layer may be disposed between the cathode 100 and the anode 130 in place of the above-described separation membrane 140.

The solid electrolyte may include a sulfide-based electrolyte. As a non-limiting example, the sulfide-based electrolyte may include Li₂S—P₂S₅, Li₂S—P₂S₅—LiCl, Li₂S—P₂S₅—LiBr, Li₂S—P₂S₅—LiCl—LiBr, Li₂S—P₂S₅—Li₂O, Li₂S—P₂S₅—Li₂O—LiI, Li₂S-SiS₂, Li₂S—SiS₂-LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are positive numbers, Z is Ge, Zn or Ga), Li₂S—GeS₂, Li₂S—SiS₂—Li₃PO₄, Li₂S—SiS₂—LiₚMO_{q} (p and q are positive numbers, M is P, Si, Ge, B, Al, Ga or In), Li₇-xPS₆-xClₓ (0≤x≤2), Li₇-xPS₆-xBrₓ (0≤x≤2), Li₇-xPS₆-xIₓ (0≤x≤2), etc. These may be used alone or in combination of two or more thereof.

In one embodiment, the solid electrolyte may include an oxide-based amorphous solid electrolyte, such as, for example, Li₂O—B₂O₃—P₂O₅, Li₂O—SiO₂, Li₂O—B₂O₃, Li₂O—B₂O₃—ZnO, etc.

As shown in FIGS. 1 and 2, electrode tabs (cathode tabs and anode tabs) may protrude from the cathode current collector 105 and the anode current collector 125, respectively, which belong to each electrode cell, and may extend to one side of the case 160. The electrode tabs may be fused together with the one side of the case 160 to form electrode leads (a cathode lead 107 and an anode lead 127) that extend or are exposed to the outside of the case 160.

The lithium secondary battery may be manufactured, for example, in a cylindrical shape using a can, a prismatic shape, a pouch shape or a coin shape.

Hereinafter, embodiments of the present disclosure will be further described with reference to specific experimental examples. However, the following examples and comparative examples included in the experimental examples are only given for illustrating the present disclosure and those skilled in the art will obviously understand that various alterations and modifications are possible within the scope and spirit of the present disclosure. Such alterations and modifications are duly included in the appended claims.

### Example 1

### (1) Preparation of First Lithium Transition Metal Oxide Particles

NiSO₄ and MnSO₄ were introduced and mixed at a molar ratio of 7:3 in distilled water from which dissolved oxygen had been removed by bubbling N₂ through it for 24 hours to prepare a mixed solution. The mixed solution was introduced into a reactor at 55° C., and a co-precipitation reaction was performed for 18 hours using NaOH as a precipitant and NH₃H₂O as a chelating agent to obtain Ni_{0.7}Mn_{0.3}(OH)₂ having a median particle diameter (D50) of 3.5 μm as a transition metal precursor. Co(OH)₂ was added and mixed with the transition metal precursor so that the cobalt content would be 14,000 ppm based on the total weight of the first lithium transition metal oxide particles. The transition metal precursor was dried at 80° C. for 12 hours, and then further dried at 110° C. for an additional 12 hours.

Lithium hydroxide and the transition metal precursor were added to a dry-type high-speed mixer at a ratio of 1.03:1 and uniformly mixed for 5 minutes. The mixture was placed in a calcination furnace under an oxygen atmosphere, heated to 950° C. at a heating rate of 2° C./min, and maintained at 950° C. for 10 hours. The product was naturally cooled to 50° C. and maintained for 5 hours. Oxygen gas was continuously supplied at a flow rate of 10 mL/min during the heating and calcination.

The calcined product was naturally cooled to room temperature, and then pulverized and classified to prepare first lithium transition metal oxide particles in the form single particles with a median particle diameter (D50) of 3.5 μm.

### (2) Preparation of Second Lithium Transition Metal Oxide Particles

NiSO₄ and MnSO₄ were introduced and mixed at a molar ratio of 7:3 in distilled water from which dissolved oxygen had been removed by bubbling N₂ through it for 24 hours to prepare a mixed solution. The mixed solution was introduced into a reactor at 55° C., and a co-precipitation reaction was performed for 36 hours using NaOH as a precipitant and NH₃H₂O as a chelating agent to obtain Ni_{0.7}Mn_{0.3}(OH)₂ having a median particle diameter (D50) of 12 μm as a transition metal precursor. Co(OH)₂ was added and mixed with the transition metal precursor so that the cobalt content would be 7,000 ppm based on the total weight of the second lithium transition metal oxide particles. The transition metal precursor was dried at 80° C. for 12 hours, and then further dried at 110° C. for an additional 12 hours.

Lithium hydroxide and the transition metal precursor were added to a dry-type high-speed mixer at a ratio of 1.03:1 and uniformly mixed for 5 minutes. The mixture was placed in a calcination furnace under an oxygen atmosphere, heated to 780° C. at a heating rate of 2° C./min, and maintained at 780° C. for 10 hours. The product was naturally cooled to 50° C. and maintained for 5 hours. Oxygen gas was continuously supplied at a flow rate of 10 ml/min during the heating and calcination.

The calcined product was naturally cooled to room temperature, and then pulverized and classified to prepare second lithium transition metal oxide particles in the form secondary particles with a median particle diameter (D50) of 12 μm.

### (3) Manufacture of a Secondary Battery

The first lithium transition metal oxide particles and the second lithium transition metal oxide particles were mixed at a weight ratio of 9:1, and were used as cathode active materials.

The cathode active material, carbon black as a conductive material, and polyvinylidene fluoride (PVdF) as a binder were mixed at a weight ratio of 93:5:2 to prepare a cathode slurry. The cathode slurry was uniformly applied to an aluminum foil (thickness: 15 μm) having a protrusion part (a cathode tab) on one side, excluding the protrusion part, then dried and roll-pressed to a density of 3.5 g/cc to fabricate a cathode.

Artificial graphite and natural graphite were mixed at a weight ratio of 7:3, and were used as anode active materials.

The anode active material, styrene-butadiene rubber as a binder, and carboxymethyl cellulose as a thickener were mixed at a weight ratio of 97:1:2 to prepare an anode slurry. The anode slurry was uniformly applied to a copper foil (thickness: 15 μm) having a protrusion part (an anode tab) on one side, excluding the protrusion part, then dried and roll-pressed to a density of 1.4 g/cc to fabricate an anode.

The cathode and anode were notched into a rectangular shape including tab leads, and a polyethylene separation membrane (thickness: 20 μm) was interposed between the cathode and anode to form an electrode assembly. A cathode lead and an anode lead were connected to the cathode tab and the anode tab, respectively, by welding. The electrode assembly was placed in a pouch (case) so that some regions of the cathode lead and anode lead were exposed to the outside, and three sides of the pouch were sealed, leaving one side as an electrolyte injection region. After injecting the electrolyte through the electrolyte injection region, the remaining side as the electrolyte injection region was also sealed, followed by impregnation for 12 hours to manufacture a secondary battery.

A solution, prepared by dissolving a 1M LiPF₆ solution (using a mixed solvent of EC/EMC/DEC in a volume ratio of 25:30:45), and further adding and mixing 1 wt % of fluoroethylene carbonate (FEC), 0.3 wt % of vinylethylene carbonate (VC), 1.0 wt % of LiPO₂F₂ (lithium difluorophosphate), 0.5 wt % of 1,3-propane sultone (PS), and 0.5 wt % of prop-1-ene-1,3-sultone (PRS) based on the total weight of the electrolyte, was used as the electrolyte.

The secondary batteries manufactured as described above were subjected to formation charging and discharging (charging conditions: CC-CV 0.24C, 4.25V, 0.1C cut-off, discharging conditions: CC 0.24C, 2.5V cut-off).

### Examples 2 to 24 and Comparative Examples 1 to 6

First lithium transition metal oxide particles, second lithium transition metal oxide particles, and secondary batteries were manufactured in the same manner as in Example 1, except that the cobalt content based on the total weight of the first lithium transition metal oxide particles and the median particle diameter (D50), the cobalt content based on the total weight of the second lithium transition metal oxide particles and the and median particle diameter (D50), the content of the first lithium transition metal oxide particles based on the total weight of the cathode active material, and the content of the second lithium transition metal oxide particles based on the total weight of the cathode active material were adjusted as described in Table 1.

### Experimental Example

### (1) Measurement of Median Particle Diameter (D50)

The median particle diameter (D50) of each of the first and second lithium transition metal oxide particles used in the examples and comparative examples described above was measured using a laser particle size analyzer (S3500 Bluewave, Microtrac).
Measurement conditions: circulation speed of 65 mL/sec
Measurement time: 10 to 30 seconds

### (2) Evaluation of High-Temperature Capacity Retention (at 45° C., 500 Cycles)

The secondary batteries according to the above-described examples and comparative examples were charged (CC-CV 1.0C, 4.25V, 0.1C cut-off) and discharged (CC 1.0C, 2.5V cut-off) for 500 cycles in a chamber at 45° C., and the discharge capacities at the 500th cycle and the first cycle were measured. There was a 10-minute rest period between each charge/discharge cycle.

The discharge capacity at the 500th cycle was divided by the discharge capacity at the first cycle and then multiplied by 100 to evaluate the high-temperature capacity retention.

### (3) Evaluation of High-Temperature Storage Characteristics (at 60° C.)

The secondary batteries according to the above-described examples and comparative examples were charged (CC-CV 0.1C, 4.25V, 0.1C cut-off) in a chamber at 25° C., and the battery capacity (initial charge capacity) was measured. The batteries were then discharged (CC 0.1C, 2.5V cut-off), and the discharge capacity (initial discharge capacity) was measured.

The secondary batteries according to the examples and comparative examples described above were stored in a chamber at 60° C. for 8 weeks, then charged (CC-CV 0.1C, 4.25V, 0.1C cut-off) and discharged (CC 0.1C, 2.5V cut-off), and the discharge capacity (high-temperature storage discharge capacity) was measured.

The high-temperature storage discharge capacity was divided by the initial discharge capacity and then multiplied by 100 to evaluate the high-temperature storage characteristics.

### (4) Measurement of Internal Resistance (DCIR)

The secondary batteries of the above-described examples and comparative examples were charged at 0.5C to reach 50% depth of discharge (DOD), and then discharged at 1C for 10 seconds. The voltage (V) drop over 10 seconds during the discharge was measured to calculate the direct current internal resistance (DCIR).

The measurement and evaluation results are shown in Tables 1 and 2.

TABLE 1

| | First lithium transition | | | Second lithium transition | | |
|---|---|---|---|---|---|---|
| | metal oxide particles | | | metal oxide particles | | |
| | Co content | D50 | Content | Co content | D50 | Content |
| | (ppm) | (μm) | (wt %) | (ppm) | (μm) | (wt %) |
| Example 1 | 14,000 | 3.5 | 90 | 7,000 | 12 | 10 |
| Example 2 | 14,000 | 3.5 | 80 | 7,000 | 12 | 20 |
| Example 3 | 14,000 | 3.5 | 70 | 7,000 | 12 | 30 |
| Example 4 | 14,000 | 3.5 | 60 | 7,000 | 12 | 40 |
| Example 5 | 14,000 | 3.5 | 50 | 7,000 | 12 | 50 |
| Example 6 | 14,000 | 3.5 | 40 | 7,000 | 12 | 60 |
| Example 7 | 14,000 | 3.5 | 30 | 7,000 | 12 | 70 |
| Example 8 | 14,000 | 3.5 | 20 | 7,000 | 12 | 80 |
| Example 9 | 14,000 | 3.5 | 10 | 7,000 | 12 | 90 |
| Example 10 | 11,000 | 3.5 | 30 | 7,000 | 12 | 70 |
| Example 11 | 15,000 | 3.5 | 30 | 7,000 | 12 | 70 |
| Example 12 | 10,000 | 3.5 | 30 | 7,000 | 12 | 70 |
| Example 13 | 14,000 | 3.5 | 30 | 5,000 | 12 | 70 |
| Example 14 | 14,000 | 3.5 | 30 | 9,000 | 12 | 70 |
| Example 15 | 14,000 | 3.5 | 30 | 4,000 | 12 | 70 |
| Example 16 | 14,000 | 3.5 | 30 | 10,000 | 12 | 70 |
| Example 17 | 14,000 | 1 | 30 | 7,000 | 12 | 70 |
| Example 18 | 14,000 | 5 | 30 | 7,000 | 12 | 70 |
| Example 19 | 14,000 | 0.5 | 30 | 7,000 | 12 | 70 |
| Example 20 | 14,000 | 5.5 | 30 | 7,000 | 12 | 70 |
| Example 21 | 14,000 | 3.5 | 30 | 7,000 | 10 | 70 |
| Example 22 | 14,000 | 3.5 | 30 | 7,000 | 15 | 70 |
| Example 23 | 14,000 | 3.5 | 30 | 7,000 | 9 | 70 |
| Example 24 | 14,000 | 3.5 | 30 | 7,000 | 16 | 70 |
| Comparative | 14,000 | 3.5 | 100 | — | — | 0 |
| Example 1 | | | | | | |
| Comparative | — | — | 0 | 7,000 | 12 | 100 |
| Example 2 | | | | | | |
| Comparative | 3,000 | 3.5 | 30 | 7,000 | 12 | 70 |
| Example 3 | | | | | | |
| Comparative | 7,000 | 3.5 | 30 | 7,000 | 12 | 70 |
| Example 4 | | | | | | |
| Comparative | 16,000 | 3.5 | 30 | 7,000 | 12 | 70 |
| Example 5 | | | | | | |
| Comparative | 14,000 | 3.5 | 30 | 16,000 | 12 | 70 |
| Example 6 | | | | | | |

TABLE 2

| | | High-temperature | |
|---|---|---|---|
| | High-temperature | storage | Internal |
| | capacity retention (%) | characteristics (%) | resistance |
| | (45° C., 500 cycles) | (60° C., 8 weeks) | (mΩ) |
| Example 1 | 87.4 | 90.7 | 4.79 |
| Example 2 | 87.0 | 91.2 | 4.77 |
| Example 3 | 87.4 | 90.2 | 4.72 |
| Example 4 | 88.2 | 89 | 4.74 |
| Example 5 | 90.7 | 89.5 | 4.38 |
| Example 6 | 91.6 | 88.7 | 3.83 |
| Example 7 | 92.0 | 89.7 | 3.71 |
| Example 8 | 92.1 | 89.3 | 3.62 |
| Example 9 | 88.1 | 88.1 | 3.59 |
| Example 10 | 89.1 | 88.6 | 3.97 |
| Example 11 | 87.3 | 87.0 | 3.63 |
| Example 12 | 87.7 | 87.5 | 4.22 |
| Example 13 | 91.4 | 88.3 | 3.95 |
| Example 14 | 92.3 | 90.3 | 3.66 |
| Example 15 | 88.7 | 87.5 | 4.51 |
| Example 16 | 88.5 | 88.1 | 3.60 |
| Example 17 | 91.1 | 88.1 | 3.70 |
| Example 18 | 90.9 | 89.5 | 3.75 |
| Example 19 | 88.5 | 87.6 | 3.77 |
| Example 20 | 88.7 | 88.0 | 3.74 |
| Example 21 | 91.5 | 89.3 | 3.65 |
| Example 22 | 91.4 | 89.5 | 3.79 |
| Example 23 | 88.9 | 87.5 | 3.78 |
| Example 24 | 89.0 | 88.8 | 3.91 |
| Comparative | 86.2 | 90.1 | 4.87 |
| Example 1 | | | |
| Comparative | 74.5 | 73.4 | 4.20 |
| Example 2 | | | |
| Comparative | 88.4 | 87.1 | 5.44 |
| Example 3 | | | |
| Comparative | 88.4 | 86.9 | 5.12 |
| Example 4 | | | |
| Comparative | 83.1 | 84.1 | 3.50 |
| Example 5 | | | |
| Comparative | 82.0 | 84.6 | 3.71 |
| Example 6 | | | |

Referring to Tables 1 and 2, in Examples 1 to 5, where both the first and second lithium transition metal oxide particles included cobalt in an amount of 15,000 ppm or less based on the total weight of each type of particles, and the cobalt content of the first lithium transition metal oxide particles was greater than that of the second lithium transition metal oxide particles, the high-temperature capacity retention, high-temperature storage characteristics, and low-resistance characteristics were improved compared to the comparative examples.

In Examples 1 to 5, where the content of the first lithium transition metal oxide particles based on the total weight of the cathode active material was outside the range of 10 wt % to 40 wt %, the high-temperature capacity retention was relatively decreased, and the internal resistance was increased compared to the other examples.

In Examples 11 and 12, where the cobalt content based on the total weight of the first lithium transition metal oxide particles was outside the range of 11,000 ppm to 14,000 ppm, the high-temperature capacity retention and high-temperature storage characteristics were relatively degraded compared to the other examples.

In Example 15, where the cobalt content based on the total weight of the second lithium transition metal oxide particles was less than 5,000 ppm, the high-temperature capacity retention and high-temperature storage characteristics were relatively degraded, and the internal resistance was increased compared to the other examples.

In Example 16, where the cobalt content based on the total weight of the second lithium transition metal oxide particles exceeded 9,000 ppm, the high-temperature capacity retention and high-temperature storage characteristics were relatively degraded compared to the other examples.

In Examples 19 and 20, where the median particle diameter (D50) of the first lithium transition metal oxide particles was outside the range of 1 μm to 5 μm, the high-temperature capacity retention and high-temperature storage characteristics were relatively degraded compared to the other examples.

In Examples 23 and 24, where the median particle diameter (D50) of the second lithium transition metal oxide particles was outside the range of 10 μm to 15 μm, the high-temperature capacity retention and high-temperature storage characteristics were relatively degraded compared to the other examples.

### DESCRIPTION OF REFERENCE NUMERALS

100: Cathode
105: Cathode current collector
107: Cathode lead
110: Cathode active material layer
120: Anode active material layer
125: Anode current collector
127: Anode lead
130: Anode
140: Separation membrane
150: Electrode assembly
160: Case

What is claimed is:

1. A cathode active material for a secondary battery comprising:
first lithium transition metal oxide particles having a single particle form and comprising cobalt in an amount of 15,000 ppm or less based on their total weight; and
second lithium transition metal oxide particles having a secondary particle form and comprising cobalt in an amount of 15,000 ppm or less based on their total weight,
wherein the cobalt content based on the total weight of the first lithium transition metal oxide particles is greater than the cobalt content based on the total weight of the second lithium transition metal oxide particles.

2. The cathode active material for a secondary battery according to claim 1, wherein the cobalt content based on the total weight of the first lithium transition metal oxide particles is 11,000 ppm to 14,000 ppm.

3. The cathode active material for a secondary battery according to claim 1, wherein the cobalt content based on the total weight of the second lithium transition metal oxide particles is 5,000 ppm to 9,000 ppm.

4. The cathode active material for a secondary battery according to claim 1, wherein the first lithium transition metal oxide particles have a median particle diameter (D50) of 1 μm to 5 μm.

5. The cathode active material for a secondary battery according to claim 1, wherein the first lithium transition metal oxide particles have a median particle diameter (D50) of 1.5 μm to 4 μm.

6. The cathode active material for a secondary battery according to claim 1, wherein the second lithium transition metal oxide particles have a median particle diameter (D50) of 10 μm to 15 μm.

7. The cathode active material for a secondary battery according to claim 1, wherein the second lithium transition metal oxide particles have a median particle diameter (D50) of 11 μm to 13 μm.

8. The cathode active material for a secondary battery according to claim 1, wherein the cobalt content based on the total weight of the first lithium transition metal oxide particles is 11,000 ppm to 14,000 ppm, the cobalt content based on the total weight of the second lithium transition metal oxide particles is 5,000 ppm to 9,000 ppm, the median particle diameter (D50) of the first lithium transition metal oxide particles is 1 μm to 5 μm, and the median particle diameter (D50) of the second lithium transition metal oxide particles is 10 μm to 15 μm.

9. The cathode active material for a secondary battery according to claim 1, wherein the first lithium transition metal oxide particles and the second lithium transition metal oxide particles each comprise a layered structure or a crystal structure represented by Formula 1 below: 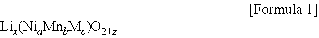
(in Formula 1, 0.9≤x≤1.2, 0.5≤a≤0.99, 0.01≤b+c≤0.5, −0.5≤z≤0.1, and M comprises Co, and optionally further comprises at least one of Al, Na, Mg, Ca, Y, Ti, Hf, V, Nb, Ta, Cr, Mo, W, Fe, Cu, Ag, Zn, B, Ga, C, Si, Sn, Sr, Ba, Ra, P and Zr).

10. The cathode active material for a secondary battery according to claim 8, wherein 0.6≤a<0.8.

11. The cathode active material for a secondary battery according to claim 1, wherein the content of the first lithium transition metal oxide particles, based on the total weight of the first lithium transition metal oxide particles and the second lithium transition metal oxide particles, is 10% by weight to 40% by weight.

12. The cathode active material for a secondary battery according to claim 1, wherein the content of the first lithium transition metal oxide particles, based on the total weight of the first lithium transition metal oxide particles and the second lithium transition metal oxide particles, is 20% by weight to 40% by weight.

13. A secondary battery comprising:
a cathode comprising the cathode active material according to claim 1; and
an anode disposed to face the cathode.

14. The secondary battery according to claim 13, wherein the cathode comprises a cathode current collector and a cathode active material layer disposed on the cathode current collector, and
the cathode active material layer comprises the first lithium transition metal oxide particles and the second lithium transition metal oxide particles.

15. The secondary battery according to claim 14, wherein the content of the first lithium transition metal oxide particles, based on the total weight of the first lithium transition metal oxide particles and the second lithium transition metal oxide particles, is 10% by weight to 40% by weight.
